(19) United States
(12) Patent Application Publication
(10) Pub. No.: US 2026/0015062 A1
(43) Pub. Date: Jan. 15, 2026

(54) TRANSMISSION APPARATUS AND WALKING DEVICE

(71) Applicant: Enwe Sports Tech (Kunshan) Co., Ltd, Suzhou (CN)

(72) Inventors: Zhidong ZHUO, Suzhou (CN); Xiaojun WANG, Suzhou (CN)

(73) Assignee: Enwe Sports Tech (Kunshan) Co., Ltd, Suzhou (CN)

(21) Appl. No.: 19/211,108

(22) Filed: May 16, 2025

(30) Foreign Application Priority Data
Jul. 12, 2024 (CN) 202421644544.7
Apr. 24, 2025 (CN) 202520785862.3

(51) Int. Cl. B62M 9/12; B62K 5/00; B62K 5/02; B62K 25/12; B62M 1/36; B62M 9/16

(52) U.S. Cl. CPC B62M 9/12; B62K 25/12; B62M 1/36; B62K 2005/001; B62K 5/02; B62M 9/16

(57) ABSTRACT

Disclosed are a transmission apparatus and a walking device. The transmission apparatus includes: a frame assembly including a first end and a second end which are arranged opposite to each other, a driving wheel disc rotationally arranged at the first end; a left driven wheel set arranged on a left side of the second end and including a left wheel and a left flywheel which rotate synchronously; a right driven wheel set arranged on a right side of the second end and including a right wheel and a right flywheel which rotate synchronously; and a transmission assembly including a differential in transmission connection with the driving wheel disc, and a left half shaft and a right half shaft arranged on a left side and a right side of the differential and in transmission connection with the differential, wherein the left half shaft is fixedly provided with a left driving flywheel.

### CROSS-REFERENCE TO RELATED APPLICATIONS

This application claims priority to Chinese Patent Application No. 202421644544.7, filed on Jul. 12, 2024, and Chinese Patent Application No. 202520785862.3, filed on Apr. 24, 2025. All of the aforementioned applications are incorporated herein by reference in their entireties.

### TECHNICAL FIELD

The present disclosure relates to the technical field of non-motorized vehicles, and in particular to a transmission apparatus and a walking device.

### BACKGROUND

As a common transportation means, non-motorized vehicles are widely used in many fields such as short-distance urban transportation, mobility for the elderly, travelling for the disabled and express delivery, and their stability and load-bearing capacity give them unique advantages in these application scenarios.

As to the existing non-motorized vehicles, such as tricycles, a front wheel is generally adopted to drive one of the rear wheels as a driving wheel, and this unilateral driving manner results in imbalanced power transmission. During driving, especially during turning or on an uneven road surface, a unilateral driving wheel is prone to skidding or loss of traction, thereby affecting stability and safety of vehicles. Moreover, when a vehicle turns, inner and outer wheels have different requirements on rotational speeds. The unilateral driving wheel fails to effectively solve the problem of differential speed, then vehicles are easily out of control during turning, especially during high-speed turning or sharp turns, and stability and maneuverability of the vehicle are poor.

### SUMMARY

In order to solve the above technical problem, the present disclosure provides a transmission apparatus which achieves bilateral drive through a double-chain configuration, thereby resulting in balanced power transmission and high driving efficiency.

The technical solutions of the present disclosure are as follows.

The present disclosure provides a transmission apparatus applied to a walking device, wherein the transmission apparatus includes:
a frame assembly including a first end and a second end which are arranged opposite to each other;
a driving wheel disc rotationally arranged at the first end;
a left driven wheel set arranged on a left side of the second end, wherein the left driven wheel set includes a left wheel and a left flywheel which rotate synchronously;
a right driven wheel set arranged on a right side of the second end, wherein the right driven wheel set includes a right wheel and a right flywheel which rotate synchronously; and
a transmission assembly including a differential, a left half shaft and a right half shaft, wherein the differential is in transmission connection with the driving wheel disc, the left half shaft and the right half shaft are arranged on a left side and a right side of the differential, respectively, the left half shaft and the right half shaft are both in transmission connection with the differential, the left half shaft is fixedly provided with a left driving flywheel, the left driving flywheel is in transmission connection with the left flywheel through a left transmission chain, the right half shaft is provided with a right driving flywheel, and the right driving flywheel is in transmission connection with the right flywheel through a right transmission chain;
wherein when the driving wheel disc rotates, the left driving flywheel and the right driving flywheel are respectively driven to rotate by the differential, and the left wheel and the right wheel are respectively driven to rotate by the left transmission chain and the right transmission chain.

Further, the left half shaft or the right half shaft is provided with a variable speed flywheel, the driving wheel disc is in transmission connection with the variable speed flywheel through a front transmission chain, and the variable speed flywheel is in transmission connection with the differential.

Further, the left wheel and the left flywheel are synchronously connected through a left rotating shaft, and the right wheel and the right flywheel are synchronously connected through a right rotating shaft.

Further, the left rotating shaft and the right rotating shaft are both provided with a first positioning member and a second positioning member, the left wheel or the right wheel is provided with a first mating portion that cooperates with the first positioning member, and the left flywheel or the right flywheel is provided with a second mating portion that cooperates with the second positioning member.

Further, the transmission apparatus further includes a left rocker arm and a right rocker arm, wherein the left rocker arm and the right rocker arm both include a first connecting end and a second connecting end which are arranged opposite to each other, the first connecting end is rotationally connected to the frame assembly, and the second connecting end is rotationally connected to the left rotating shaft or the right rotating shaft.

Further, the first connecting end is rotationally connected to the frame assembly through a dual-locking assembly, the first connecting end includes two connecting arms, each of the connecting arms is formed with a first connecting hole, the frame assembly is provided with a connecting channel, the dual-locking assembly includes a dual-locking screw and a dual-locking screw barrel, the dual-locking screw barrel penetrates through the first connecting hole and the connecting channel in sequence to be fixedly connected to the dual-locking screw.

Further, the dual-locking screw barrel is coaxially arranged with the left half shaft or the right half shaft.

Further, a shock absorption assembly is arranged between the left rocker arm and the frame assembly and between the right rocker arm and the frame assembly, the shock absorption assembly includes a guide rod and a shock absorption spring, the shock absorption spring is sleeved on the guide rod, one end of the guide rod is rotationally connected to the left rocker arm and the right rocker arm, and the other end is rotationally connected to the frame assembly.

Further, a tensioning member is arranged on the left rocker arm and the right rocker arm, and the tensioning member is configured to adjust the tension of the left transmission chain and the right transmission chain.

The present disclosure further provides a walking device including a driving portion and the above transmission apparatus, wherein the driving portion is configured to drive the driving wheel disc.

The present disclosure has the following beneficial technical effects.

The transmission apparatus of the present disclosure has advantages of simple structure, easy maintenance, fewer parts and components, reduced manufacturing costs, reduced overall weight of the transmission apparatus, and improved manoeuvrability and energy efficiency of the walking device. The power of the driving wheel disc is transmitted to a left half shaft and a right half shaft respectively through a differential, and then the left wheel and the right wheel are respectively driven to rotate by the left driving flywheel and the right driving flywheel, so as to achieve efficient distribution of power, ensure that the left wheel and the right wheel may obtain appropriate power output under different road conditions, and maintain stability and manoeuvrability of a vehicle. Moreover, the left wheel and the right wheel are capable of automatically adjusting the rotational speed difference according to a driving state of the walking device (e.g., during turning or on an uneven road surface), so as to improve the adaptability to the ground and reduce wheel skidding or idling, and further improve the applicability and passability of the walking device. In addition, the left wheel and the right wheel are connected to the left driving flywheel and the right driving flywheel through the left transmission chain and the right transmission chain respectively, thereby avoiding the problems of power loss and imbalanced power transmission of the traditional single-chain transmission. The transmission apparatus achieving bilateral drive through a double-chain configuration not only balances power transmission with a high driving efficiency, but also effectively shortens the power transmission path, reduces energy loss in the transmission step, and makes the power response speed faster.

### BRIEF DESCRIPTION OF THE DRAWINGS

FIG. 1 shows a walking device according to Embodiment I of the present disclosure.

FIG. 2 shows a walking device according to Embodiment II of the present disclosure.

FIG. 3 is a structural schematic diagram of a transmission apparatus (with the left wheel and the right wheel being removed) in FIG. 1.

FIG. 4 is an enlarged view of a circled portion in FIG. 3.

FIG. 5 is a structural schematic diagram of a transmission assembly and a rocker arm assembly in FIG. 3.

FIG. 6 is a schematic diagram of the assembly of a rocker arm assembly and a driven wheel set in FIG. 1.

FIG. 7 is a schematic diagram showing connection of a controller.

### DETAILED DESCRIPTION OF THE EMBODIMENTS

In order to more clearly understand the technical means of the present disclosure and to allow implementation according to contents of the specification, specific embodiments of the present disclosure are described in further detail below in combination with the accompanying drawings and embodiments, and the following embodiments are used to illustrate the present disclosure, rather than limiting the scope of the present disclosure.

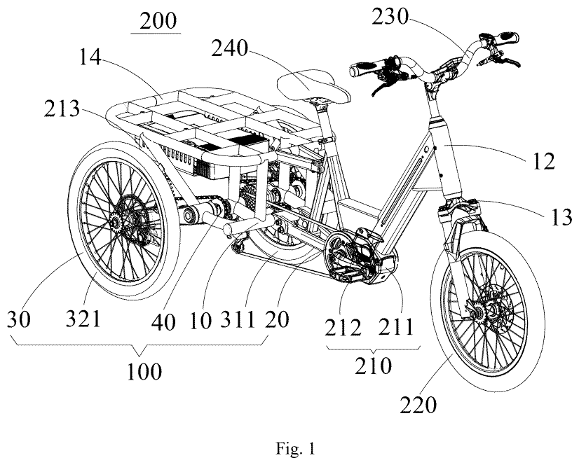

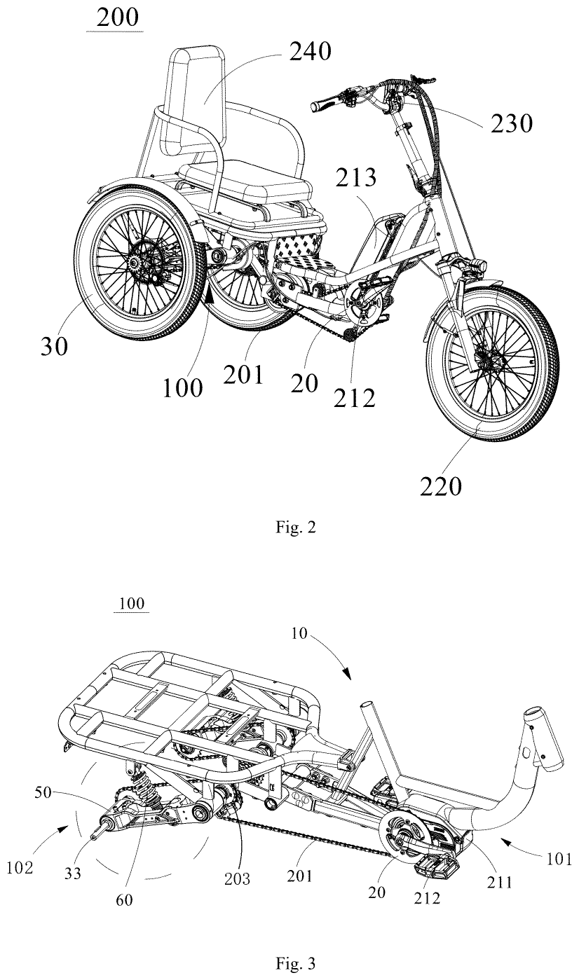

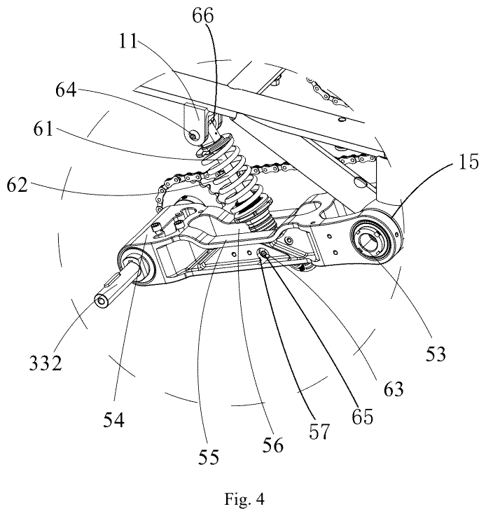

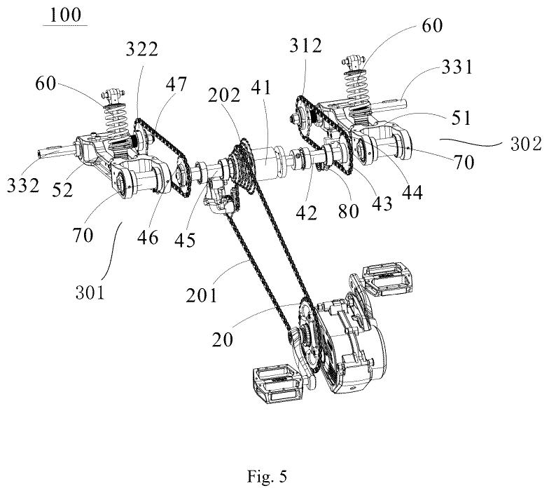

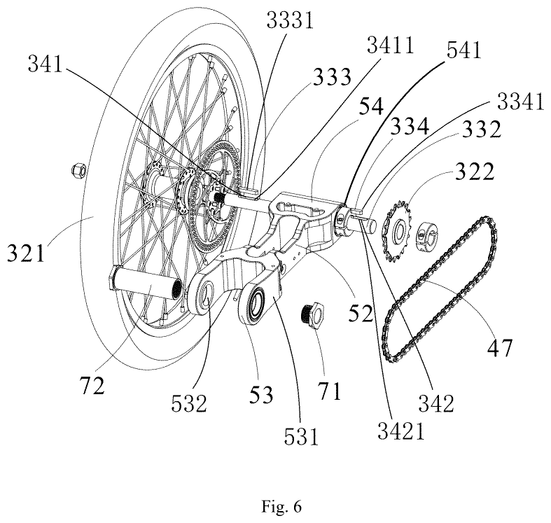

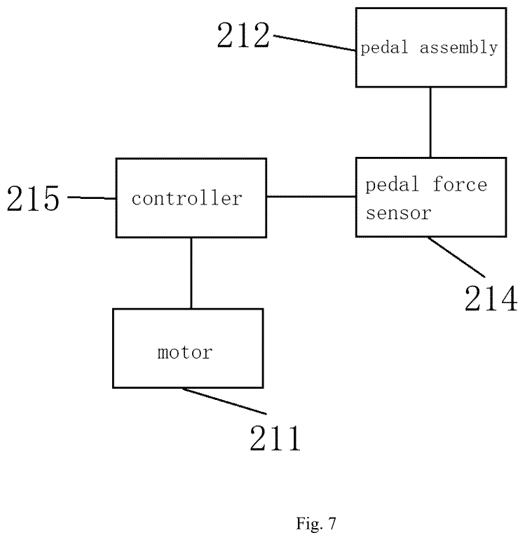

Referring to FIG. 1 to FIG. 6, the present disclosure discloses a walking device 200. The walking device 200 may be a tricycle (as in FIG. 1) or a recumbent bicycle (as in FIG. 2), a three-wheeled power-assisted bicycle, a three-wheeled bicycle, a four-wheeled non-motorized vehicle (e.g., a quadricycle for children), and so on, and the present disclosure is not limited in any way herein.

The walking device 200 includes a driving portion 210, a transmission apparatus 100, a handle assembly 230, a steering wheel 220, a seat 240, a shock absorption assembly 60 and other structures. Wherein, the driving portion 210 provides power for the walking device 200, including human-powered drive, electric drive, and hybrid drive of human-powered drive and electric drive. The transmission apparatus 100 includes a frame assembly 10, a driven wheel assembly 30, a transmission assembly 40, and a shock absorption assembly 60. In this embodiment, the driven wheel assembly 30 is a rear wheel assembly arranged at the rear of the frame assembly 10, and the steering wheel 220 is a front wheel arranged at the front of the frame assembly 10. Of course, in other embodiments, the driven wheel set 30 may also be arranged at the front of the frame assembly 10, and the steering wheel 220 is arranged at the rear. The present disclosure does not limit in this regard.

It should be noted that in the present disclosure, the structure of the transmission apparatus 100 employed by the tricycle of FIG. 1 is the same as the structure of the transmission apparatus 100 employed by the recumbent bicycle of FIG. 2. For the sake of clarity of description, the walking device 200 in the following specification is described in detail below using the tricycle of FIG. 1 as an example, but this should not be taken as a limitation.

Referring to FIG. 1 and in combination with FIG. 3 to FIG. 6, the present disclosure discloses a tricycle. The tricycle includes a transmission apparatus 100, a driving portion 210, a steering wheel 220, a handle assembly 230, a seat 240, etc.

Referring to FIG. 3 to FIG. 6 and in combination with FIG. 1, the transmission apparatus 100 includes a frame assembly 10, a driven wheel assembly 30, a rocker arm assembly 50, a shock absorption assembly 60, a driving wheel disc 20, and a transmission assembly 40.

As a main structure of a tricycle, the frame assembly 10 runs through front and rear ends of the tricycle, and provides a mounting basis for all the components. The frame assembly 10 includes a first end 101 and a second end 102 which are arranged opposite to each other. Wherein the first end 101 is connected to the driving wheel disc 20, and the second end 102 is connected to the driven wheel assembly 30, thereby providing a supporting and mounting basis for the entire transmission apparatus 100.

The driving wheel disc 20 is rotationally arranged at the first end 101 of the frame assembly 10, and is typically located at the front portion or the middle portion of the walking device 200, close to the steering wheel 220. The driving wheel disc 20 is in transmission connection with the driving portion 210 and is in transmission connection with the transmission assembly 40 through the front transmission chain 201. The driving portion 210 drives the driving wheel disc 20 to rotate, and drives the transmission assembly 40 to rotate, and further drives the driven wheel assembly 30 to rotate, so as to achieve a walking function of the walking device 200. The driving wheel disc 20 is arranged to ensure that the power may be efficiently transmitted to the driven wheel assembly 30.

Optionally, the driving portion 210 may be driven by human power or electric power. In this embodiment, the walking device 200 further includes a motor 211, a pedal assembly 212 and a power battery 213, wherein the motor 211 and the pedal assembly 212 are arranged to be close to the driving wheel disc 20, and the power battery 213 is electrically connected to the motor 211.

In this embodiment, a frame rear triangle 14 for carrying objects or people is arranged at the rear of the frame assembly 10. A power battery 213 is arranged underneath the frame rear triangle 14. The power battery 213 is electrically connected to the motor 211, so as to drive the driving wheel disc 20 to rotate through the motor 211. Of course, in other embodiments, the power battery 213 may also be arranged at other positions, for example, close to the motor 211, and so on.

In this embodiment, the pedal assembly 212 is electrically connected to the motor 211, and by stepping on the pedal assembly 212, a pedal force sensor 214 detects a stepping signal and transmits the signal to a controller 215 of the motor 211, and the controller 215 of the motor 211 adjusts the output power of the motor 211 according to the strength and frequency of the signal. The pedal assembly 212 provides power to the motor 211, such that the motor 211 may more efficiently utilize electrical energy during operation. Moreover, this cooperative working mode of human power and electric power makes riding easier, especially during climbing a slope or carrying a heavy load, the physical burden on the rider is significantly reduced. Of course, in other embodiments, the pedal assembly 212 may also be in direct transmission connection with the driving wheel disc 20, and power is directly provided to the driving wheel disc 20 by treading on the pedal assembly 212. The present disclosure does not limit in this regard.

The driven wheel assembly 30 includes a left driven wheel set 301 and a right driven wheel set 302. The left driven wheel set 301 and the right driven wheel set 302 are arranged on the left side and the right side of the second end 102 of the frame assembly 10, respectively. The driven wheel assembly 30 is connected to the driving wheel disc 20 through a transmission assembly 40 to receive power and drive the walking device 200 to move forward.

In this embodiment, a left driven wheel set 301 is arranged on the left side of the second end 102, and the left driven wheel set 301 includes a left wheel 311 and a left flywheel 312 which rotate synchronously. A right driven wheel set 302 is arranged on the right side of the second end 102, and the right driven wheel set 302 includes a right wheel 321 and a right flywheel 322 which rotate synchronously. The transmission assembly 40 includes a differential 41, a left half shaft 42 and a right half shaft 45, wherein the differential 41 is in transmission connection with the driving wheel disc 20, the left half shaft 42 and the right half shaft 45 are respectively arranged on the left side and the right side of the differential 41, the left half shaft 42 and the right half shaft 45 are both in transmission connection with the differential 41, the left half shaft 42 is fixedly provided with a left driving flywheel 43, the left driving flywheel 43 is in transmission connection with the left flywheel 312 through a left transmission chain 44, the right half shaft 45 is provided with a right driving flywheel 46, and the right driving flywheel 46 is in transmission connection with the right flywheel 322 through a right transmission chain 47.

When the driving wheel disc 20 rotates, the left driving flywheel 43 and the right driving flywheel 46 may be respectively driven to rotate by the differential 41, and the left wheel 311 and the right wheel 321 are respectively driven to rotate by the left transmission chain 44 and the right transmission chain 47. That is, the power of the driving wheel disc 20 is transmitted to the left half shaft 42 and the right half shaft 45 respectively by the differential 41, and further the left wheel 311 and the right wheel 321 are respectively driven to rotate by the left driving flywheel 43 and the right driving flywheel 46, so as to achieve efficient distribution of power, ensure that the left wheel 311 and the right wheel 321 may obtain appropriate power output under different road conditions, and maintain stability and manoeuvrability of a vehicle.

Moreover, the left wheel 311 and the right wheel 321 are capable of automatically adjusting the rotational speed difference according to a driving state of the walking device 200 (e.g., during turning or on an uneven road surface), so as to improve the adaptability to the ground and reduce wheel skidding or idling, and further improve the applicability and passability of the walking device 200.

In addition, the left wheel 311 and the right wheel 321 are connected to the left driving flywheel 43 and the right driving flywheel 46 through the left transmission chain 44 and the right transmission chain 47, respectively, thereby avoiding the problems of power loss and imbalanced power transmission of the traditional single-chain transmission. The transmission apparatus 100 achieving bilateral drive through a double-chain configuration not only balances power transmission with a high driving efficiency, but also effectively shortens the power transmission path, reduces energy loss in the transmission step, and makes the power response speed faster. That is, in the transmission apparatus 100 of this embodiment, the driving wheel disc 20 allows the driven wheels on both sides to be driven through double chains, such that the power transmission is balanced, and the driving efficiency is high; moreover, the transmission apparatus 100 has advantages of simple structure, easy maintenance, fewer parts and components, reduced manufacturing costs, reduced overall weight of the transmission apparatus 100, and improved manoeuvrability and energy efficiency of the walking device 200.

Of course, in other embodiments, the transmission assembly 40 may also be of other structures, as long as the power on the driving wheel disc 20 may be provided to the left wheel 311 and the right wheel 321, respectively. The present disclosure does not limit in this regard.

Further, the left wheel 311 and the left flywheel 312 are synchronously connected through a left rotating shaft 331, and the right wheel 321 and the right flywheel 322 are synchronously connected through a right rotating shaft 332. Wherein the left transmission shaft 331 and the right transmission shaft 332 may be collectively referred to as a rotating shaft assembly 33. Through such as setting, power is directly transmitted from the flywheels to the wheels, thereby avoiding relative skidding between the wheels and the flywheels, ensuring that the power may be transmitted to the wheels smoothly and efficiently, and further improving the acceleration performance and the hill climbing ability of the vehicle.

Further, the left rotating shaft 331 and the right rotating shaft 332 are both provided with a first positioning member 333 and a second positioning member 334, the left wheel 311 or the right wheel 321 is provided with a first mating portion 341 that cooperates with the first positioning member 333, and the left flywheel 312 or the right flywheel 322 is provided with a second mating portion 342 that cooperates with the second positioning member 334. Through such a setting, precise synchronous rotation of the wheel and the flywheel is ensured, and skidding during transmission is reduced.

In this embodiment, the first positioning member 333 is a long key 3331 arranged on the rotating shaft assembly 33, and the second positioning member 334 is a short key 3341 arranged on the rotating shaft assembly 33. The first mating portion 341 is a first groove 3411 arranged on the left wheel 311 or the right wheel 321, and the second mating portion 342 is a second groove 3421 arranged on the left flywheel 312 or the right flywheel 322. The long key 3331 and the short key 3341 both protrude from the rotating shaft assembly 33, and cooperate with the first groove 3411 and the second groove 3421, respectively, so as to achieve quick positioning and connection and achieve a fool-proofing effect, further prevent the wheel and the flywheel from skidding during rotation, and improve the precision of synchronous rotation.

Further, the left half shaft 42 or the right half shaft 45 is provided with a variable speed flywheel 202, the driving wheel disc 20 is in transmission connection with the variable speed flywheel 202 through a front transmission chain 201, and the variable speed flywheel 202 is in transmission connection with the differential 41. By arranging the variable speed flywheel 202 on the left half shaft 42 or the right half shaft 45, the power of the driving wheel disc 20 may be transmitted to the variable speed flywheel 202 through the front transmission chain 201, and then is transmitted to the differential 41 through the variable speed flywheel 202. The variable speed flywheel 202 is capable of selecting different speed ratios according to the operation of a rider, thereby realizing multi-speed transmission, improving adaptability, and optimizing the efficiency of power transmission.

Further, the front transmission chain 201 is further provided with a rear derailleur 203 which is used in cooperation with the variable speed flywheel 202

Referring to FIG. 3 to FIG. 6, the transmission apparatus 100 further includes a rocker arm assembly 50 and a shock absorption assembly 60. Separation shock absorption of the two left wheels 311 and right wheels 321 is realized through the rocker arm assembly 50 and the shock absorption assembly 60, so as to improve the comfort, stability, and manoeuvrability of the walking device 200.

The rocker arm assembly 50 includes a left rocker arm 51 and a right rocker arm 52, wherein the left rocker arm 51 and the right rocker arm 52 both include a first connecting end 53 and a second connecting end 54 which are arranged opposite to each other, the first connecting end 53 is rotationally connected to the frame assembly 10, and the second connecting end 54 is rotationally connected to the left driven wheel set 301 or the right driven wheel set 302. The two shock absorption assemblies 60 are arranged between the left rocker arm 51 and the frame assembly 10 and between the right rocker arm 52 and the frame assembly 10 respectively.

By arranging an independent shock absorption assembly 60 between the left rocker arm 51 and the frame assembly 10 and between the right rocker arm 52 and the frame assembly 10 respectively, an independent shock absorption function of the two driven wheel sets is achieved, thereby more accurately absorbing vibration from the ground, reducing the vibration transmitted to the frame assembly 10 and the rider, and enhancing the comfort of riding. The independent shock absorption assembly 60 may avoid the problems of delayed shock absorption effect and vibration transmission caused by overall linkage, and ensures quick response of the shock absorption assembly 60 and its ability to efficiently absorb high-frequency vibration. Moreover, the independent shock absorption assembly 60 may automatically adjust the shock absorption strength according to the load condition and optimize the load performance.

In addition, the left driven wheel set 301 and the right driven wheel set 302 of the present disclosure are connected to the frame assembly 10 through the left rocker arm 51 and the right rocker arm 52, respectively, and this structure allows the driven wheels to independently adjust the angle of contact with the ground and the pressure under complicated road conditions. During turning or passing through an uneven road surface, the left rocker arm 51 and the right rocker arm 52 are able to rotate up and down with the first connecting end 53 as a centre, and under the action of the shock absorption assembly 60, the two driven wheel sets are able to achieve flexible up and down movement under the action of gravity, such that each of the driven wheels is able to maintain a good traction, and further the stability and maneuverability of the vehicle are improved. In the present disclosure, by setting an independent shock absorption assembly 60 at the two driven wheel sets to cooperate with the rocker arm assembly 50, adaptive adjustment of the walking device 200 under different road conditions may be achieved, and the overall use experience of users is improved.

Optionally, in this embodiment, since the left rocker arm 51 and the right rocker arm 52 have the same structure, only the right rocker arm 52 is taken as an example for detailed description herein.

The right rocker arm 52 includes a first connecting end 53, a second connecting end 54, and two connecting arms 55, wherein the first connecting end 53 and the second connecting end 54 are arranged opposite to each other, and the two connecting arms 55 connect the first connecting end 53 and the second connecting end 54. A mounting portion 57 configured to mount the shock absorption assembly 60 and an avoidance space 56 configured to avoid the shock absorption assembly 60 are arranged between the two connecting arms 55. Through arranging a mounting portion 57 between the two connecting arms 55, the shock absorption assembly 60 may be precisely positioned and secured.

This design ensures that the shock absorption assembly 60 will not shift or shake during operation, thereby improving the stability of the entire shock absorption system. Moreover, the mounting portion 57 is designed to enable the shock absorption assembly 60 to be tightly integrated inside the left rocker arm 51, thereby reducing the occupation of an external space and making the structure of the entire transmission apparatus 100 more compact. In addition, the avoidance space 56 between the two connecting arms 55 provides a sufficient movement space for the shock absorption assembly 60. During a driving process of the walking device 200, the shock absorption assembly 60 needs to perform telescopic movement to absorb vibration according to road conditions. The avoidance space 56 ensures that the shock absorption assembly 60 will not be interfered by the structure of the left rocker arm 51 during movement, then the shock absorption assembly 60 is capable of performing telescopic movement freely, thereby reducing the friction and resistance between the shock absorption assembly 60 and the right rocker arm 52 during movement, and improving the response speed and efficiency of the shock absorption system. In addition, through the design of the mounting portion 57 and the avoidance space 56, the shock absorption assembly 60 is mounted and disassembled more conveniently. The maintenance personnel may quickly replace or repair the shock absorption assembly 60, then assembly time and maintenance costs are reduced.

Further, the first connecting end 53 is rotationally connected to the frame assembly 10 through the dual-locking assembly 70. Such a setting ensures stable and reliable connection and improves flexibility of assembly and ease of maintenance. Moreover, the first connecting end 53 is rotationally connected to the frame assembly 10 through the dual-locking assembly 70, then the left rocker arm 51 rotates up and down around the first connecting end 53, and the left driven wheel set 301 is capable of independently adjusting the angle of contact with the ground and the pressure according to road conditions, thereby optimizing the shock absorption performance and the passability of vehicles, ensuring that each driven wheel set maintains a good traction under complicated road conditions, and improving maneuverability and stability of vehicles. In addition, a dual-locking mechanism of the dual-locking assembly 70 is capable of bearing a larger load, ensuring that the walking device 200 maintains a stable connection and a reliable shock absorption performance even under loaded conditions.

The first connecting end 53 includes two connecting arms 531, each of the connecting arms 531 is provided with a first connecting hole 532, the frame assembly 10 is provided with a connecting channel 15, the dual-locking assembly 70 includes a dual-locking screw 71 and a dual-locking screw barrel 72, and the dual-locking screw barrel 72 penetrates through the first connecting hole 532 and the connecting channel 15 in sequence to be fixedly connected to the dual-locking screw 71. When the walking device 200 (e.g., a tricycle) drives on a bumpy road, the right rocker arm 52 swings up and down with the centre of the dual-locking screw barrel 72 as a rotational centre and absorbs vibration through the shock absorption assembly 60, thereby reducing the vibration transmitted to the frame and the rider and improving the comfort of driving.

The second connecting end 54 is rotationally connected to the right driven wheel set 302 through the rotating shaft assembly 33. Specifically, the second connecting end 54 is sleeved on the right rotating shaft 332 through a second connection hole 541 and is arranged between the first positioning member 333 and the second positioning member 334. When the right rotating shaft 332 rotates under the drive of the right flywheel 322, the right rocker arm 52 remains relatively stationary, such that the movement of the shock absorption system is relatively independent from the power transmission system, and the shock absorption system is able to respond to the impact of the ground more freely without being interfered by the power transmission system.

Further, the dual-locking screw barrel 72 is arranged coaxially with the left half shaft 42 or the right half shaft 45. Through such a setting, the length of a connecting line between the center of the right driving flywheel 46 and the center of the right flywheel 322 is the same as the length of a connecting line between the first connecting end 53 and the second connecting end 54 of the right rocker arm 52. That is, when the right rocker arm 52 swings up and down with the centre of the dual-locking screw barrel 72 as a rotational centre, the tensioning length of the right transmission chain 47 remains unchanged uniformly and is always in a stable state of tensioning, and no slackness or over-tensioning due to up and down movement of the right rocker arm 52 occurs, thereby improving stability and reliability of the transmission system. Moreover, a stable tensioning state not only avoids excessive stretching or compression of the chain during movement and prolongs the service life of the chain and the sprocket, but also reduces jittering and shaking of the chain during movement, further reduces vibration transmitted to the frame assembly 10 and the rider, and improves the comfort of the vehicle.

Further, the shock absorption assembly 60 includes a guide rod 61 and a shock absorption spring 62 sleeved on the guide rod 61, wherein the guide rod 61 includes a first rotating end 63 and a second rotating end 64 which are arranged opposite to each other, the first rotating end 63 is rotationally connected to the left rocker arm 51 or the right rocker arm 52, and the second rotating end 64 is rotationally connected to the frame assembly 10. When the shock absorption spring 62 is sleeved on the guide rod 61, the shock absorption spring 62 may be elastically deformed when impacted by the ground and may absorb vibration from the ground, such that the driven wheel set is able to achieve flexible up and down movement under the action of the shock absorption spring 62, and the shock absorption ability is improved. When the two ends of the guide rod 61 are respectively rotationally connected to the left rocker arm 51 or the right rocker arm 52 and the frame assembly 10, stability of the shock absorption assembly 60 during movement is ensured, thereby reducing the risk of failure caused by loosening or deformation of the structure, and improving reliability of the entire shock absorption system.

The first rotating end 63 of the guide rod 61 is at least partially located in the avoidance space 56 and is rotationally connected to the two connecting arms 531 through the first rotating shaft 65. Through such a setting, a sufficient space is provided for the movement of the shock absorption assembly 60 to ensure that the guide rod 61 does not interfere with the connecting arm 531 during up and down movement, and the existence of the avoidance space 56 allows the shock absorption assembly 60 to perform a telescopic movement freely, thereby reducing the resistance to movement and improving the response speed and efficiency of the shock absorption system.

An extension arm 11 is arranged on a side, facing towards the rocker arm assembly 50, of the frame assembly 10, and the second rotating end 64 is rotationally connected to the extension arm 11 through a second rotating shaft 66. Such a setting enhances the strength of connection between the shock absorption assembly 60 and the frame assembly 10. The rotational connection not only provides sufficient freedom of movement, but also ensures that the shock absorption assembly 60 is able to transmit force and torque smoothly during movement.

Further, the left rocker arm 51 and the right rocker arm 52 are both provided with a tensioning member 80. The tensioning member 80 is configured to adjust the tension of the left transmission chain 44 and the right transmission chain 47. The tensioning member 80 is arranged to adjust the tension of the transmission chain according to actual requirements, so as to ensure that the transmission chain always maintains a proper tensioning state under different working conditions, and to avoid unstable power transmission or increased wear of the chain caused by slackness or excessive tensioning of the transmission chain. Moreover, the tensioning member 80 is also configured to enable the transmission chain to remain stable in the process of movement, thereby reducing jittering and shaking of the transmission chain, and improving the reliability of the transmission system.

The handle assembly 230 and the steering wheel 220 are arranged close to the first end (generally a front end) of the frame assembly 10. Referring to FIG. 1, the handle assembly 230 is assembled with the frame assembly 10 and the steering wheel 220 through the frame front triangle 12. Moreover, a front fork 13 is further arranged between the steering wheel 220 and the frame front triangle 12. The steering operation of the tricycle is achieved through cooperation between the handle assembly 230 and the steering wheel 220, thereby enabling the rider to conveniently follow intentions of the rider during driving. In addition, the handle assembly 230 also provides a hand support for the rider, such that the rider easily maintains balance and stability during driving. Further, the handle assembly 230 also integrates such control devices as an accelerator and a brake handle to facilitate operation by the rider.

The seat 240 is located in the middle portion or the rear portion of the frame assembly 10, and is typically located between the steering wheel 220 and the driven wheel assembly 30, so as to provide a comfortable riding position for the rider.

In summary, the transmission apparatus 100 of the present disclosure has advantages of simple structure, easy maintenance, fewer parts and components, reduced manufacturing costs, reduced overall weight of the transmission apparatus 100, and improved manoeuvrability and energy efficiency of the walking device 200. The power of the driving wheel disc 20 is transmitted to the left half shaft 42 and the right half shaft 45 respectively through a differential 41, and then the left wheel 311 and the right wheel 321 are driven to rotate by the left driving flywheel 43 and the right driving flywheel 46, so as to achieve efficient distribution of power, ensure that the left wheel 311 and the right wheel 321 may obtain appropriate power output under different road conditions, and maintain stability and manoeuvrability of the vehicle. Moreover, the left wheel 311 and the right wheel 321 are capable of automatically adjusting the rotational speed difference according to a driving state of the walking device 200 (e.g., during turning or on an uneven road surface), so as to improve the adaptability to the ground and reduce wheel skidding or idling, and further improve the applicability and passability of the walking device 200. In addition, the left wheel 311 and the right wheel 321 are respectively connected to the left driving flywheel 43 and the right driving flywheel 46 through the left transmission chain 44 and the right transmission chain 47, thereby avoiding the problems of power loss and imbalanced power transmission of the traditional single-chain transmission. The transmission apparatus 100 achieving bilateral drive through a double-chain configuration not only balances power transmission with a high driving efficiency, but also effectively shortens the power transmission path, reduces energy loss in the transmission step, and makes the power response speed faster.

The above are merely preferred embodiments of the present disclosure and are not intended to limit the present disclosure. It should be noted that, for those skilled in the art, a number of improvements and variations may be made without departing from the technical principles of the present disclosure, and these improvements and variations shall all fall within the protection scope of the present disclosure.

What is claimed is:

1. A transmission apparatus applied to a walking device, comprising:
a frame assembly comprising a first end and a second end which are arranged opposite to each other;
a driving wheel disc rotationally arranged at the first end;
a left driven wheel set arranged on a left side of the second end, wherein the left driven wheel set comprises a left wheel and a left flywheel which rotate synchronously;
a right driven wheel set arranged on a right side of the second end, wherein the right driven wheel set comprises a right wheel and a right flywheel which rotate synchronously; and
a transmission assembly comprising a differential, a left half shaft and a right half shaft, wherein the differential is in transmission connection with the driving wheel disc, the left half shaft and the right half shaft are arranged on a left side and a right side of the differential, respectively, the left half shaft and the right half shaft are both in transmission connection with the differential, the left half shaft is fixedly provided with a left driving flywheel, the left driving flywheel is in transmission connection with the left flywheel through a left transmission chain, the right half shaft is provided with a right driving flywheel, and the right driving flywheel is in transmission connection with the right flywheel through a right transmission chain;
wherein when the driving wheel disc rotates, the left driving flywheel and the right driving flywheel are respectively driven to rotate by the differential, and the left wheel and the right wheel are respectively driven to rotate by the left transmission chain and the right transmission chain.

2. The transmission apparatus according to claim 1, wherein the left half shaft or the right half shaft is provided with a variable speed flywheel, the driving wheel disc is in transmission connection with the variable speed flywheel through a front transmission chain, and the variable speed flywheel is in transmission connection with the differential.

3. The transmission apparatus according to claim 1, wherein the left wheel and the left flywheel are synchronously connected through a left rotating shaft, and the right wheel and the right flywheel are synchronously connected through a right rotating shaft.

4. The transmission apparatus according to claim 3, wherein the left rotating shaft and the right rotating shaft are both provided with a first positioning member and a second positioning member, the left wheel or the right wheel is provided with a first mating portion that cooperates with the first positioning member, and the left flywheel or the right flywheel is provided with a second mating portion that cooperates with the second positioning member.

5. The transmission apparatus according to claim 3, further comprising a left rocker arm and a right rocker arm, wherein the left rocker arm and the right rocker arm both comprise a first connecting end and a second connecting end which are arranged opposite to each other, the first connecting end is rotationally connected to the frame assembly, and the second connecting end is rotationally connected to the left rotating shaft or the right rotating shaft.

6. The transmission apparatus according to claim 5, wherein the first connecting end is rotationally connected to the frame assembly through a dual-locking assembly, the first connecting end comprises two connecting arms, each of the connecting arms is formed with a first connecting hole, the frame assembly is provided with a connecting channel, the dual-locking assembly comprises a dual-locking screw and a dual-locking screw barrel, and the dual-locking screw barrel penetrates through the first connecting hole and the connecting channel in sequence to be fixedly connected to the dual-locking screw.

7. The transmission apparatus according to claim 6, wherein the dual-locking screw barrel is coaxially arranged with the left half shaft or the right half shaft.

8. The transmission apparatus according to claim 5, wherein a shock absorption assembly is arranged between the left rocker arm and the frame assembly and between the right rocker arm and the frame assembly, the shock absorption assembly comprises a guide rod and a shock absorption spring, the shock absorption spring is sleeved on the guide rod, one end of the guide rod is rotationally connected to the left rocker arm and the right rocker arm, and the other end is rotationally connected to the frame assembly.

9. The transmission apparatus according to claim 5, wherein a tensioning member is arranged on the left rocker arm and the right rocker arm, and the tensioning member is configured to adjust the tension of the left transmission chain and the right transmission chain.

10. A walking device, comprising a driving portion and the transmission apparatus according to claim 1, wherein the driving portion is configured to drive the driving wheel disc.
